(19) United States
(12) Patent Application Publication
(10) Pub. No.: US 2013/0325411 A1
(43) Pub. Date: Dec. 5, 2013

(54) TOPOGRAPHY SIMULATION APPARATUS, TOPOGRAPHY SIMULATION METHOD AND RECORDING MEDIUM

(71) Applicant: KABUSHIKI KAISHA TOSHIBA, Tokyo (JP)

(72) Inventor: Takashi ICHIKAWA, Saitama-Shi (JP)

(73) Assignee: KABUSHIKI KAISHA TOSHIBA, Tokyo (JP)

(21) Appl. No.: 13/773,444

(22) Filed: Feb. 21, 2013

(30) Foreign Application Priority Data
May 30, 2012 (JP) 2012-123500

(51) Int. Cl. G06F 17/50

(52) U.S. Cl. CPC G06F 17/5009
USPC 703/1

(57) ABSTRACT

In one embodiment, a topography simulation apparatus includes a division module configured to divide a surface of a substance into a plurality of computing elements. The apparatus further includes a determination module configured to extend straight lines in a plurality of directions from each computing element, and configured to determine whether each straight line contacts the surface of the substance and determine which computing element each straight line contacts. The apparatus further includes a calculation module configured to calculate, based on results of the determinations, a direct flux which is a flux of a reactive species directly reaching each computing element, and a form factor indicating a positional relationship between the computing elements.

### CROSS REFERENCE TO RELATED APPLICATION

This application is based upon and claims the benefit of priority from the prior Japanese Patent Application No. 2012-123500, filed on May 30, 2012, the entire contents of which are incorporated herein by reference.

### FIELD

Embodiments described herein relate to a topography simulation apparatus, a topography simulation method and a recording medium.

### BACKGROUND

When a surface of a substance is processed by chemical vapor deposition (CVD), reactive ion etching (RIE) or the like, a simulation of topography of the processed surface is an important technique. In this simulation, the surface of the substance is generally divided into computing elements such as points, lines, or polygons to calculate a flux of a reactive species reaching each computing element and a local surface grow rate of the substance. When the surface of the substrate is processed, the topography of the processed surface is affected not only by a reactive species directly reaching the surface but also by a reactive species indirectly reaching the surface after temporarily contacting another surface. However, a long calculation time is required to consistently calculate the flux and the surface growth rate on the entire surface in consideration of these reactive species. This is because the calculation time increases with the square order of the number of the computing elements.

### BRIEF DESCRIPTION OF THE DRAWINGS

FIG. 1 is a flowchart illustrating a procedure of a topography simulation method of a first embodiment;

FIG. 2 is a perspective view illustrating an example of an initial structure of a substrate of the first embodiment;

FIG. 3 is a schematic diagram for illustrating a level set function;

FIG. 4 is a flowchart illustrating details of step S3 in FIG. 1;

FIG. 5 is a schematic diagram illustrating a substance surface divided into computing elements;

FIG. 6 is a flowchart illustrating details of step S12 in FIG. 4;

FIGS. 7A and 7B are diagrams for illustrating a local coordinate system;

FIG. 8 is a schematic diagram for illustrating a visibility determination value;

FIG. 9 is a schematic diagram for illustrating a visibility factor;

FIG. 10 is a schematic diagram for illustrating an incident angle θᵢₙ;

FIG. 11 is a schematic diagram for illustrating a mirror boundary condition;

FIG. 12 is a schematic diagram for illustrating a periodic boundary condition;

FIG. 13 is a schematic diagram for illustrating a two-dimensional computing element visibility determination value;

FIG. 14 is a schematic diagram for illustrating a three-dimensional computing element visibility determination value;

FIG. 15 is a flowchart illustrating a modification of a procedure of steps S22 to S27 in FIG. 6;

FIGS. 16A and 16B are diagrams for illustrating a global coordinate system;

FIG. 17 is a graph illustrating an example of calculation time in a comparative example;

FIG. 18 is a graph illustrating an example of calculation time in the first embodiment;

FIG. 19 is a graph illustrating a comparison between the calculation time of the first embodiment and the comparative example;

FIG. 20 is a graph illustrating a relation between a “θ” division number and a calculation error in the first embodiment and the comparative example;

FIG. 21 is an outline view illustrating a configuration of a topography simulation apparatus of a second embodiment; and

FIG. 22 is a block diagram illustrating a configuration of a control module of FIG. 21.

### DETAILED DESCRIPTION

Embodiments will now be explained with reference to the accompanying drawings. In the drawings, identical or similar components are denoted by identical reference numerals, and a redundant description thereof is omitted as needed.

In one embodiment, a topography simulation apparatus includes a division module configured to divide a surface of a substance into a plurality of computing elements. The apparatus further includes a determination module configured to extend straight lines in a plurality of directions from each computing element, and configured to determine whether each straight line contacts the surface of the substance and determine which computing element each straight line contacts. The apparatus further includes a calculation module configured to calculate, based on results of the determinations, a direct flux which is a flux of a reactive species directly reaching each computing element, and a form factor indicating a positional relationship between the computing elements.

### First Embodiment

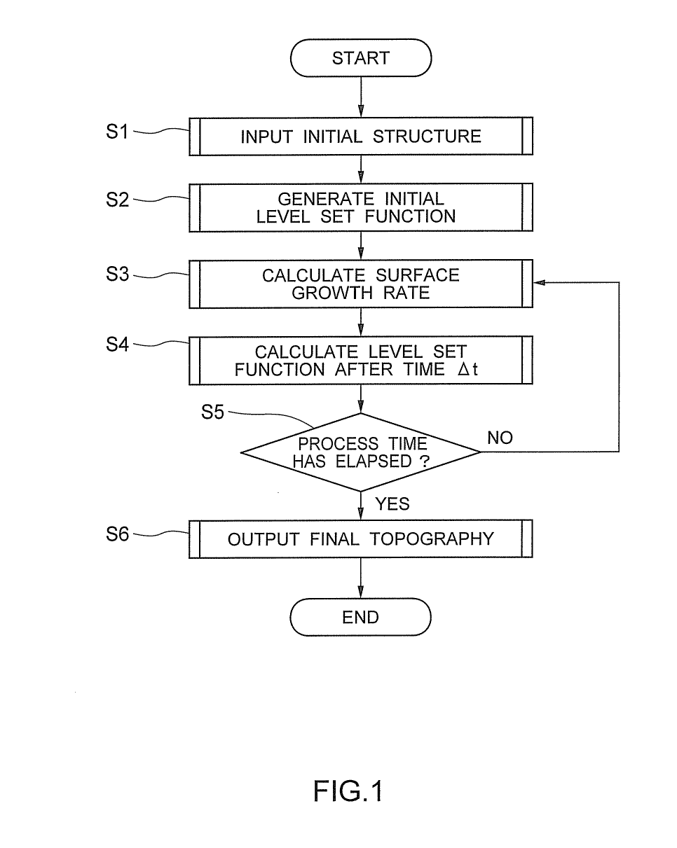

FIG. 1 is a flowchart illustrating a procedure of a topography simulation method of a first embodiment. The topography simulation method of this embodiment is carried out using an information processing apparatus such as a personal computer or a work station.

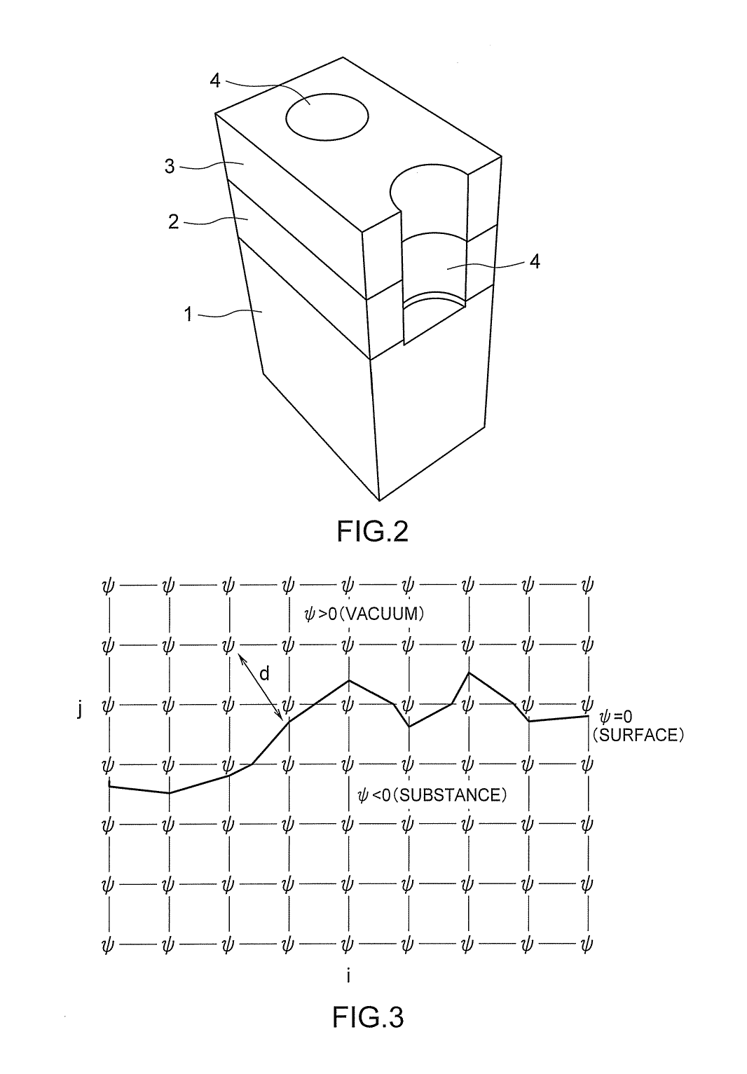

In the topography simulation method of this embodiment, an initial structure of a substance is inputted to an information processing apparatus (step S1). FIG. 2 is a perspective view illustrating an example of the initial structure of the substrate of the first embodiment. The initial structure illustrated in FIG. 2 includes a silicon substrate 1, a silicon nitride film 2 and a silicon oxide film 3 formed in this order on the silicon substrate 1, and through holes 4 penetrating the silicon nitride film 2 and the silicon oxide film 3. Various formats may be used as examples of the method of inputting the initial structure. In this embodiment, however, a method is employed in which the topography of a substance surface is expressed by a sequence of points to be read by the information processing apparatus.

Next, an initial level set function is generated from the input initial structure (step S2). FIG. 3 is a schematic diagram for illustrating a level set function. A level set function φ is a function defined using a distance “d” from the surface of the substance, and has a value for each mesh within a calculating area. The value of the level set function φ is (φ=0) which is defined as 0 at the surface of the substance. Further, φ>0 holds at the outside (in vacuum) of the substance, and φ<0 holds at the inside of the substance (in the substance). In the case of generating the initial level set function, a surface closest to each mesh point is searched, and the distance “d” is calculated. Further, when a mesh point is in vacuum, a positive sign is set, and when the mesh point is within the substance, a negative sign is set. The initial level set function may be input in step S1, instead of being generated in step S2.

Next, a local surface growth rate “F” of the substance is calculated (step S3). It is assumed herein that the surface growth includes not only deposition on the surface but also etching of the surface. There is no need to calculate the surface growth rate “F” for each time step. In this embodiment, as described later, the surface growth rate “F” is calculated from the flux (total flux) on the surface of the substance, and the level set function is calculated from the surface growth rate “F”. Alternatively, the level set function may be calculated from the flux, and the calculation of the surface growth rate “F” may be omitted.

Next, the level set function after a lapse of a time Δt is calculated using the surface growth rate “F” (step S4). The level set function φₜ at a time t can be calculated from the following formula (1).

φₜ+F|∇φₜ|=0 (1)

where ∇ represents a vector differential operator, |∇_{φt}| represents a norm of ∇_{φt}. The level set function after a lapse of the time Δt allows calculation by performing time evolution on the level set function in accordance with a formula obtained by discretizing the formula (1). In this embodiment, the surface growth rate “F” and the flux in certain surface topography may be calculated, instead of performing the time evolution on the surface topography. This corresponds to the case where step S5 described later is determined as Yes in a first step.

Next, it is determined whether a preset process time has elapsed or not (step S5). When the process time is ended, the final topography of the substance is outputted (step S6), and the calculation ends. When the process time is not ended, the process returns to step S3.

In this embodiment, a level set method is employed as a technique for expressing the topography, but techniques, such as a cell method and a string method, other than the level set method may be employed.

(1) Details of Step S3

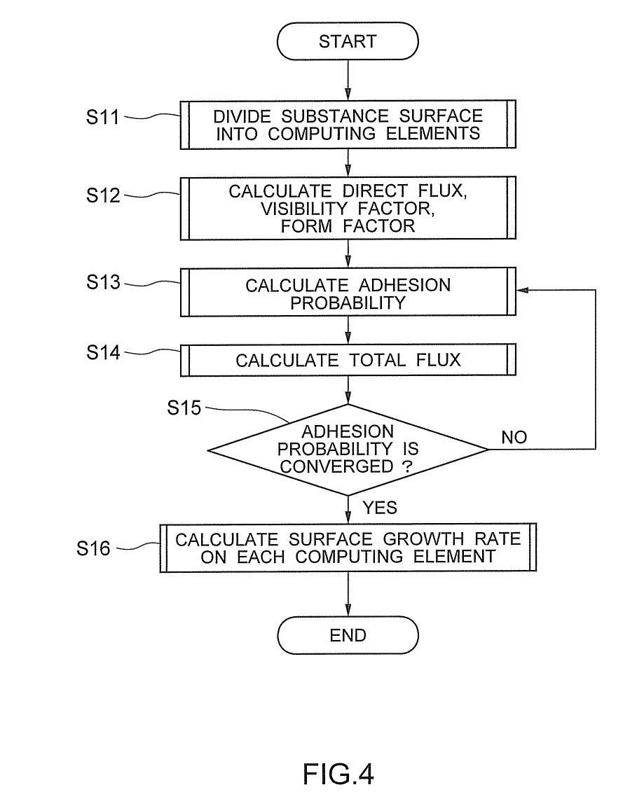

Referring next to FIG. 4, step S3 will be described in detail.

FIG. 4 is a flowchart illustrating details of step S3 in FIG. 1.

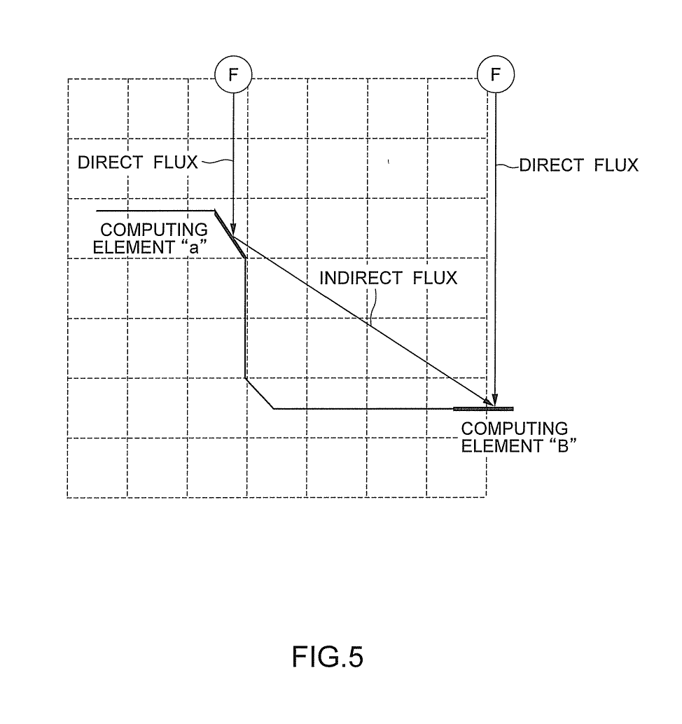

First, the substance surface represented by the level set method is divided into a plurality of computing elements (step S11). FIG. 5 is a schematic diagram illustrating the substance surface divided into the computing elements. In the example of FIG. 5, the substance surface is divided for each mesh. As a result, the substance surface within one mesh is one computing element. A block that performs the process of step S11 is an example of a division module of the disclosure.

The method of dividing the substance surface is not limited to the unit of mesh, but any method may be employed. The division of the substance surface is not necessarily performed for each time step, but may be performed immediately after step S1, for example.

Though the calculation area illustrated in FIG. 5 is a two-dimensional area, a three-dimensional area may be used instead. The shape of each computer element illustrated in FIG. 5 is a line segment, but a point, a polygon, or the like may be used instead.

FIG. 5 illustrates a first computing element “a” and a second computing element “B”. In the case of calculating the flux of the reactive species reaching the computing element “B”, the flux of the reactive species directly reaching the computing element “B” from a gas space, and the flux of the reactive species indirectly reaching the computing element “B” through any computing element “a” from the gas space are generally taken into consideration. The former flux is referred to as a direct flux, and the latter flux is referred to as an indirect flux. The sum of these fluxes is referred to as a total flux. Examples of the reactive species include a deposition species and an etching species.

The total flux Γ_{B} in the computing element “B” is represented by the sum of the direct flux Γ_{B,direct} in the computing element “B” and the indirect flux Γ_{aB,indirect} from the any computing element “a” as the following formula (2).

$${Γ}_{B} = {Γ}_{B , direct} + {\sum }_{a = 1}^{A} {Γ}_{aB , indirect} \qquad ( 2 )$$

where the indirect flux Γ_{aB,indirect} can be expressed by the following formula (3), for example.

Γ_{ab,indirect}=(1−Sₐ(Γₐ))ν(a,B)g(a,B)Γₐ (3)

where Sₐ(Γₐ) represents an adhesion probability indicating a ratio of the flux absorbed on each computing element “a”. The value of Sₐ(Γₐ) depends on the total flux Γₑ in each computing element “a”. Further, ν(a, B) represents a visibility factor (face-to-face visibility factor) indicating whether the computing element “a” and the computing element “B” are visible to each other. When the straight line connecting the computing elements “a” and “B” contacts the substance surface, ν=0 holds. When the straight line does not contact the substrate surface, ν=1 holds. Further, g(a, B) represents a form factor illustrating a positional relationship (face relation) between the computing element “a” and the computing element “B”. The value of g(a, B) represents a degree at which the computing elements “a” and “B” are visible to each other. The value of g(a, B) depends on the distance and angle between the computing elements “a” and “B”.

When the formula (2) is substituted into the formula (3), the total flux Γ_{B} in the computing element “B” can be represented by the following formula (4).

$${Γ}_{B} = {Γ}_{B , direct} + {\sum }_{a = 1}^{A} ( 1 - {S}_{a} ( {Γ}_{a} ) ) v ( a , B ) g ( a , B ) {Γ}_{a} \qquad ( 4 )$$

In the flow of FIG. 4, the direct flux in any computing element, and the visibility factor ν and the form factor “g” between arbitrary computing elements are then calculated (step S12).

Next, a direct flux Γ_{i,direct} of each computing element “i” is used as a temporal total flux F, and an adhesion probability Sᵢ(Γᵢ) in each computing element “i” is calculated (step S13). In this case, this flux may include neutral molecules, ions having directivity, or the both thereof.

Next, the total flux Γᵢ in each computing element “i” is calculated from the following formula (5) by using the visibility factor ν, the form factor “g”, the direct flux Γ_{i,direct}, and the adhesion probability Sᵢ(Γᵢ) (step S14).

$${Γ}_{i , direct} = {Γ}_{i} - {\sum }_{a = 1}^{A} ( 1 - {S}_{a} ( {Γ}_{a} ) ) v ( a , B ) g ( a , B ) {Γ}_{a} \qquad ( 5 )$$

Next, the processes of steps S13 and S14 are repeated until the value of the adhesion probability Sᵢ(Fᵢ) is converged (step S15). In the second and subsequent step S13, the total flux Γᵢ, which is calculated in the previous step S14, is used as the temporal total flux Γᵢ. In step S15, it is determined whether the value of Sᵢ(Γᵢ) is converged or not based on whether a change in Sᵢ(Γ₁) is equal to or smaller than a threshold. The total flux Γᵢ obtained when the value of Sᵢ(Γᵢ) is converged is treated as a correct calculation result of the total flux Γᵢ.

Assuming that the number of computing elements is “N”, the visibility factor ν and the form factor “g” between arbitrary computing elements can be collectively expressed as N×N matrix. The visibility factor ν and the form factor “g”, which are represented by a matrix form, are respectively referred to as a visibility factor matrix and a form factor matrix. The flux in any computing element can be represented by an N-row vector. The flux represented by a vector form is referred to as a flux vector.

In this case, the formula (5) can be expressed by a matrix equation as in the following formula (6).

$$\begin{matrix}A {\vec{Γ}}_{i} = {\vec{Γ}}_{i , direct} & ( 6 ) \\ {\vec{Γ}}_{i} = [ \begin{matrix}{Γ}_{1} \\ {Γ}_{2} \\ ⋮ \\ {Γ}_{i} \\ ⋮ \\ {Γ}_{I}\end{matrix} ] & ( 7 ) \\ {\vec{Γ}}_{i , direct} = [ \begin{matrix}{Γ}_{1 , direct} \\ {Γ}_{2 , direct} \\ ⋮ \\ {Γ}_{i , direct} \\ ⋮ \\ {Γ}_{I , direct}\end{matrix} ] & ( 8 ) \\ A = [ \begin{matrix}1 + ( {S}_{1} ( {Γ}_{1} ) - 1 ) v ( 1 , 1 ) g ( 1 , 1 ) & ( {S}_{2} ( {Γ}_{2} ) - 1 ) v ( 1 , 2 ) g ( 1 , 2 ) & … & ( {S}_{j} ( {Γ}_{j} ) - 1 ) v ( 1 , j ) g ( 1 , j ) & … & ( {S}_{J} ( {Γ}_{J} ) - 1 ) v ( 1 , J ) g ( 1 , J ) \\ ( {S}_{1} ( {Γ}_{1} ) - 1 ) v ( 2 , 1 ) g ( 2 , 1 ) & 1 + ( {S}_{2} ( {Γ}_{2} ) - 1 ) v ( 2 , 2 ) g ( 2 , 2 ) & … & ( {S}_{j} ( {Γ}_{j} ) - 1 ) v ( 2 , j ) g ( 2 , j ) & … & ( {S}_{J} ( {Γ}_{J} ) - 1 ) v ( 2 , J ) g ( 2 , J ) \\ ⋮ & ⋮ & ⋱ & ⋮ & … & ⋮ \\ ( {S}_{1} ( {Γ}_{1} ) - 1 ) v ( i , 1 ) g ( i , 1 ) & ( {S}_{2} ( {Γ}_{2} ) - 1 ) v ( i , 2 ) g ( i , 2 ) & … & 1 + ( {S}_{j} ( {Γ}_{j} ) - 1 ) v ( i , j ) g ( i , j ) & … & ( {S}_{J} ( {Γ}_{J} ) - 1 ) v ( i , J ) g ( i , j ) \\ ⋮ & ⋮ & ⋮ & ⋮ & ⋱ & ⋮ \\ ( {S}_{1} ( {Γ}_{1} ) - 1 ) v ( I , 1 ) g ( I , 1 ) & ( {S}_{2} ( {Γ}_{2} ) - 1 ) v ( I , 2 ) g ( I , 2 ) & … & ( {S}_{j} ( {Γ}_{j} ) - 1 ) v ( I , j ) g ( I , j ) & … & 1 + ( {S}_{J} ( {Γ}_{J} ) - 1 ) v ( I , J ) g ( I , J )\end{matrix} ] & ( 9 )\end{matrix}$$

where “I”, “J” represents the number of computing elements to be processed, and I=J=N holds, for example. The matrix equation (6) may be solved by any solution. Examples of the solution include an iterative method (Gauss-Seidel method, SOR method, Jacobi method, conjugate gradient method, etc.), and a direct method (Gaussian elimination, LU decomposition method, Choleski decomposition method, etc.). In the case of solving the matrix equation (6), when the matrix “A” is a sparse matrix, memory saving and speed-up of the calculation process may be achieved by using a routine suitable for the sparse matrix using a storage method such as CRS.

In the flow of FIG. 4, a local surface growth rate Fᵢ on each computing element “i” is then calculated from the total flux Γᵢ (step S16). For example, in the case of using “K” types of reactive species, the surface growth rate Fᵢ is modeled in the form of the following formula (10) depending on “K” local total fluxes Γ_{1,i} to Γ_{K,i}.

Fᵢ=f(Γ_{1,i}, . . . , Γ_{k,i} . . . , Γ_{K,i}) (10)

where “k” is any real number that satisfies 1≦k≦K. As described above, the process of step S3 is ended.

(2) Details of Step S12

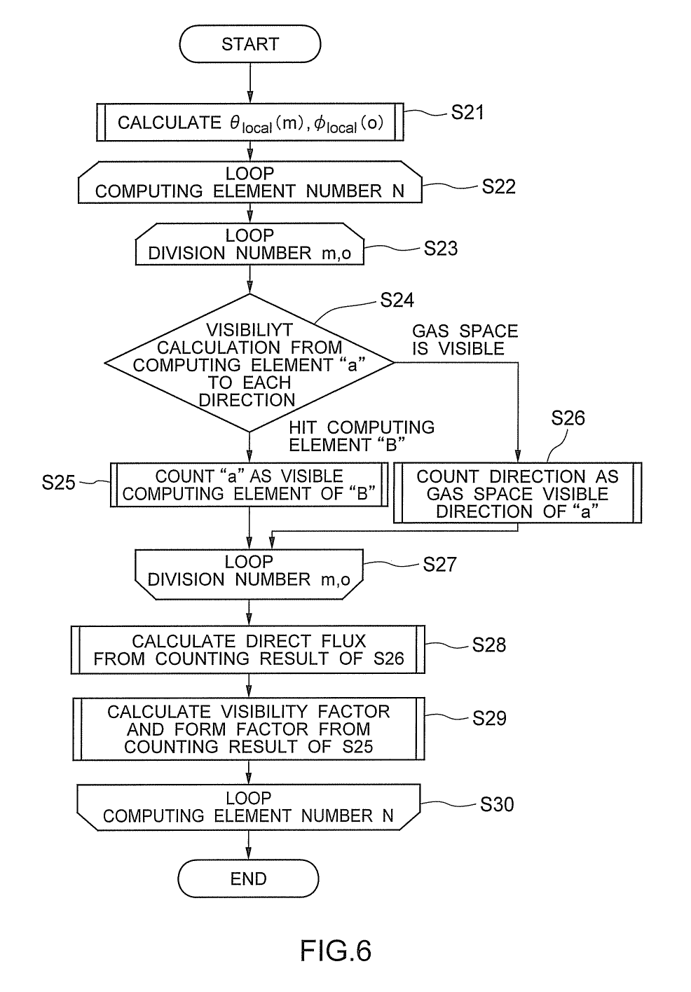

Referring next to FIG. 6, step S12 will be described in detail.

FIG. 6 is a flowchart illustrating details of step S12 in FIG. 4.

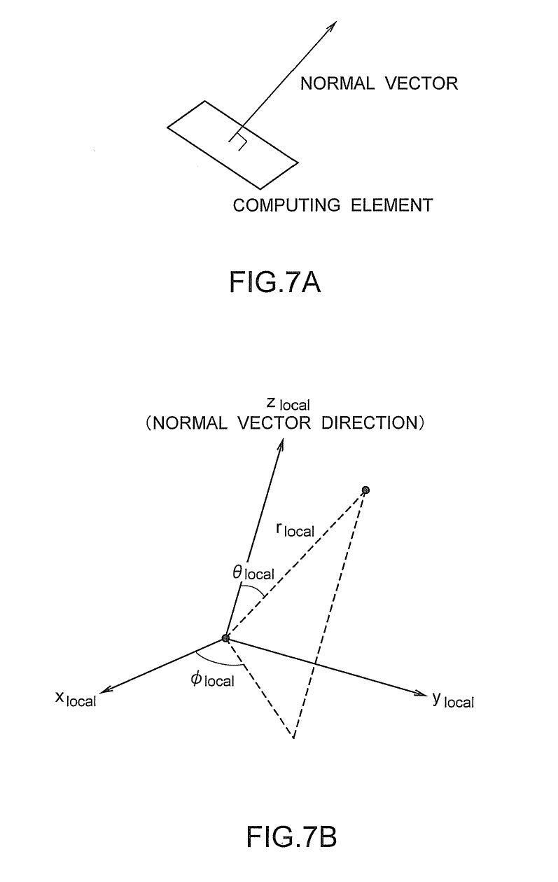

In the flow of FIG. 6, a local coordinate system unique to each computing element is used. FIGS. 7A and 7B are diagrams for illustrating a local coordinate system. FIG. 7A illustrates a normal vector of each computing element, and FIG. 7B illustrates a local coordinate system in each computing element. As illustrated in FIG. 7B, the orthogonal coordinates (x_{local}, y_{local}, Z_{local}) of the local coordinate system are determined such that a +z_{local} direction coincides with a normal vector direction. The polar coordinates (r_{local}, θ_{local}, φ_{local}) of the local coordinate system is determined such that the zenith angle φ_{local} becomes an angle between the radius vector r_{local} and the +z_{local} direction and that the azimuth angle φ_{local} becomes an angle between the radius vector r_{local} and the +x_{local} direction.

The direct flux Γ_{B,direct} in the computing element “B” is calculated by the following formula (11).

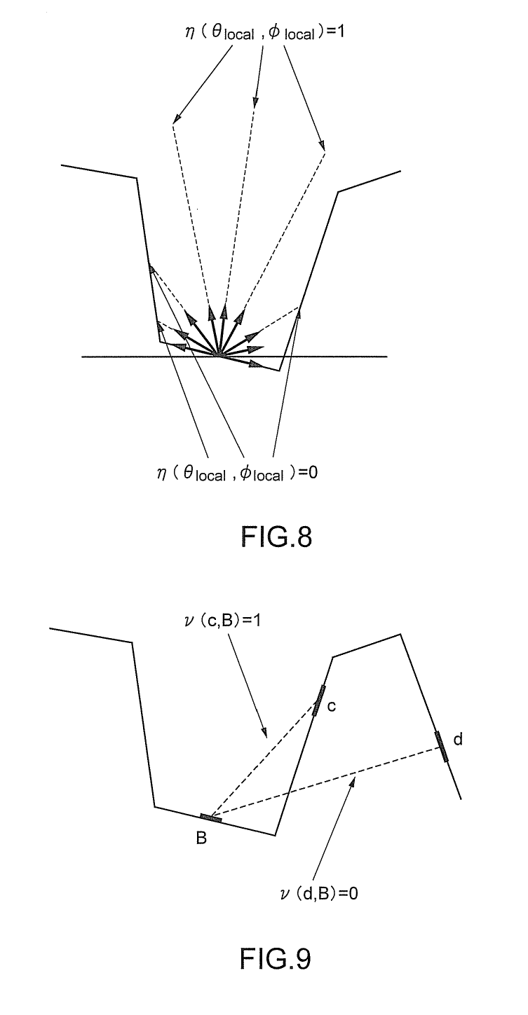

Γ_{B,direct}=f_{flat}Norm∫₀^{2π}∫₀^{π}η(θ_{local},φ_{local})f(θ_{local})|sin θ_{local}|dθ_{local}dφ_{local} (11)

where η(θ_{local}, φ_{locat}) represents a visibility determination result when a straight line is extended in the directions of θ_{local} and φ_{local} from the computing element “B”, and is referred to as a visibility determination value. FIG. 8 is a schematic diagram for illustrating the visibility determination value η. As illustrated in FIG. 8, when the straight line contacts the substance surface, η=0 holds. When the straight line does not contact the substance surface, η=1 holds. As illustrated in FIG. 8, when the straight line is extended only in the direction on one side of the substance surface, the integral range of θ_{local} in the formula (11) is from 0 to π, or may be from 0 to π/2.

As to the difference between the visibility determination value η and the visibility factor ν, see FIG. 9. FIG. 9 is a schematic diagram for illustrating the visibility factor ν. Here, ν(a, B) indicates whether the computing element “a” and the computing element “B” are visible to each other. When the straight line connecting the computing elements “a” and “B” contacts the substance surface between the computing elements “a” and “B”, ν=0 holds. When the straight line does not contact the substance surface, ν=1 holds. See a computing element “d” as an example of the former case, and see a computing element “c” as an example of the latter case.

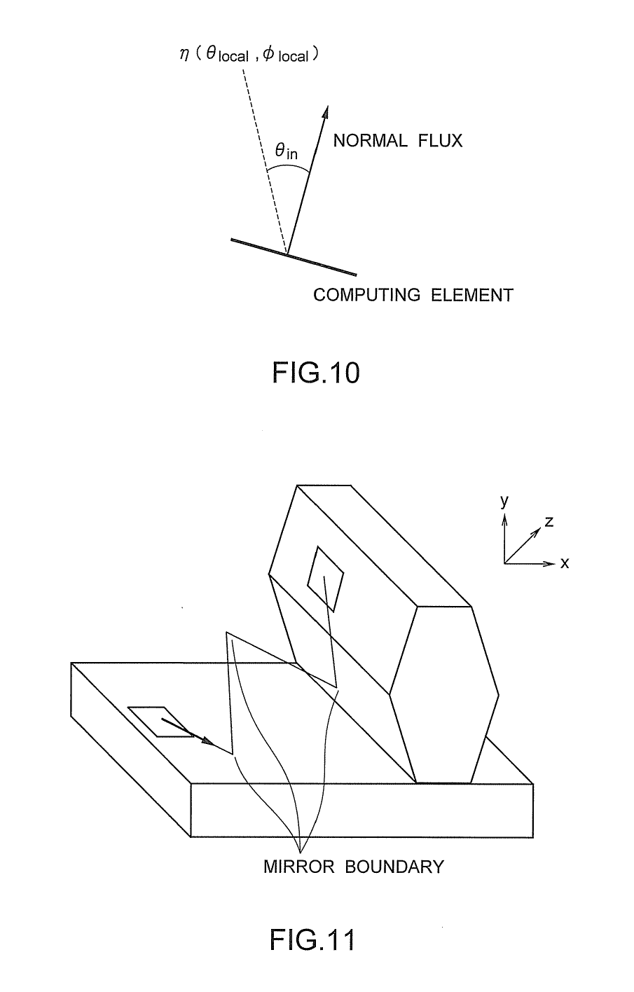

Further, f_{flat} represents a direct flux at a flat surface, and is given in advance as an input value. In addition, Norm represents a normalization constant given by the following formula (12), and f(θ_{local}) represents a factor of an area fragment of a direct flux, and is given by the following formula (13), for example.

$$\begin{matrix}Norm = \frac{N + 1}{2 π} & ( 12 ) \\ f ( {θ}_{local} ) = {cos}^{N - 1} {θ}_{local} cos {θ}_{in} & ( 13 )\end{matrix}$$

where θᵢₙ represents an incident angle as illustrated in FIG. 10. FIG. 10 is a schematic diagram for illustrating the incident angle θᵢₙ. The incident angle θᵢₙ corresponds to the angle between the normal vector direction and the θ_{local} and φ_{local} directions. Accordingly, in the case of using the local coordinate system (r_{local}, θ_{local}, φ_{local}), θᵢₙ=θ_{1ocal} holds.

The flow of FIG. 6 will be described in detail below.

First, the value of the sequence θ_{local}(m) of the zenith angle θ_{local} (m=0, 1, . . . , M−1) and the value of the sequence φ_{local}(m) of the azimuth angle φ_{local} (o=0, 1, . . . , O−1) are calculated (step S21). This corresponds to division of the range of the zenith angle θ_{local} from 0 to π into “M” areas and division of the range of azimuth angle φ_{local} from 0 to 2π into “O” areas. As described later, the integral calculation of the formula (11) is discretized using the sequences θ_{local}(m) and φ_{local}(o).

In the case of using the area fragment factor illustrated in the formula (13) is used for the calculation of the direct flux Γ_{B,direct} of the formula (11), the sequences θ_{local}(m) and φ_{local}(o) as represented by the following formulas (14) and (15) are prepared.

$$\begin{matrix}{θ}_{local} ( m ) = {cos}^{- 1} ( {( 1 - \partial ( m ) )}^{\frac{1}{N + 1}} ) & ( 14 ) \\ {φ}_{local} ( o ) = \frac{2 π ( o + 0.5 )}{O} & ( 15 )\end{matrix}$$

where the sequence ∂(m) is given by the following formula (16).

$$\partial ( m ) = \frac{m + 0.5}{M} \qquad ( 16 )$$

where θ_{local}(m) of the formula (14) represents an angle at which the integral result becomes ∂(m) when f(θ_{local})|sin θ_{local| is integrated from θ}_{local}=0 to θ_{local}=θ_{local}(m). The relation of the formula (17) is established from the definition, and the formula (18) is deduced from the formula (17) and is transformed to thereby obtain the formula (14).

∂(m)=[−cos^{N+1}θ_{local}]₀⁰^{_{local}}^{(m)} (17)

∂(m)=1−cos^{N+1}θ_{local}(m) (18)

As described above, in step S21, the range of the zenith angle θ_{local} from 0 to π is divided at irregular intervals, and the range of the azimuth angle φ_{local} from 0 to 2π is divided at regular intervals. In this embodiment, not only the range of the zenith angle θ_{local}, but also the range of the azimuth angle φ_{local} may be divided at irregular intervals. When the integral range of the zenith angle θ_{local} is set from 0 to π/2, the range of the zenith angle θ_{local} not from 0 to π but from 0 to π/2 may be divided into “M” areas.

Next, straight lines are extended in a plurality of directions from each computing element “a”, and it is determined whether each straight line contacts the substance surface, and determined which computing element each straight line contacts (step S24). The directions in which the straight lines are extended from each computing element “a” is determined by the sequences θ_{local}(m) and φ_{local}(o) in each computing element “a”. Specifically, in step S24, the straight lines are extended in the directions of θ_{local}(m) and φ_{local}(o) from each computing element “a”. Accordingly, M×O straight lines are extended from each computing element “a”. The process of step S24 is performed for each of the “N” computing elements “a”. A block that performs the process of step S24 is an example of a determination module of the disclosure.

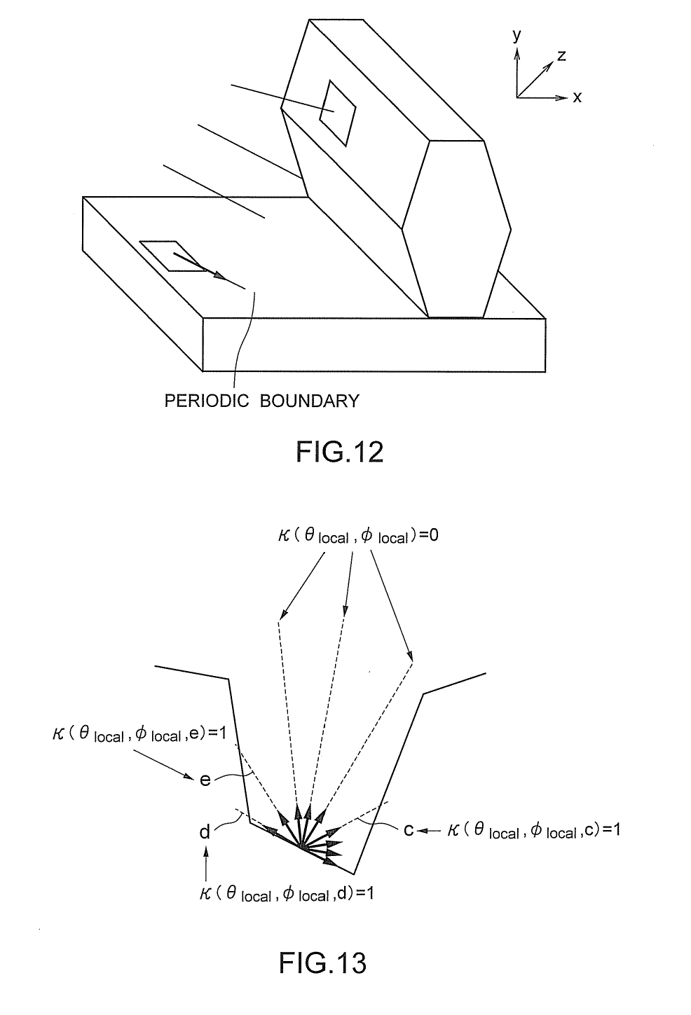

In step S24, the visibility determination may be performed in consideration of a mirror boundary condition and a periodic boundary condition. FIGS. 11 and 12 are schematic diagrams for illustrating the mirror boundary condition and the periodic boundary condition, respectively. Such a determination makes it possible to perform flux calculation incorporating the boundary condition at low cost.

As described above, in step S24, it is determined whether each straight line from a plurality of computing elements “a” contacts the substance surface, and determined which computing element each straight line contacts. The process of step S25 is performed for the straight line that contacts the substance surface, and the process of step S26 is performed for the straight line that does not contact the substance surface.

In step S25, when any straight line from a computing element “a” contacts the computing element “B”, the computing element “a” is counted as a visible computing element of the computing element “B”. On the other hand, when no straight line from a computing element a contacts the computing element B, the computing element “a” is not counted as the visible computing element of the computing element “B”. Such a process is performed on all the computing elements “a”, thereby specifying all the computing elements “a” that are visible from the computing element “B”. This process is not limited to the computing element B, but is performed on all the “N” computing elements in a similar manner.

On the other hand, in step S26, when a straight line from a computing element “a” does not contact the substance surface (i.e., reaches the gas space), the direction of the straight line is counted as a gas space visible direction of the computing element “a”. Such a process is performed on all straight lines, thereby specifying all the directions in which the reactive species directly reaches each computing element “a” from the gas space. This specification result can be used for calculation of the direct flux. For example, the counting result of the gas space visible direction of the computing element “B” is used for the calculation of the direct flux in the computing element “B”.

In the flow of FIG. 6, the direct flux Γ_{B,direct} on the computing element “B” is then calculated by using the counting result of step S26 (step S28). The direct flux Γ_{B,direct} is expressed as the following formula (19) by discretizing the formula (11) using the sequences θ_{local}(m) and φ_{local}(o)

$${Γ}_{B , direct} = \frac{{f}_{flat}}{M \times O} {\sum }_{m}^{M} {\sum }_{o}^{O} η ( {θ}_{Blocal} ( m ) , {φ}_{Blocal} ( o ) ) \qquad ( 19 )$$

where θ_{Blocal}(m) and φ_{Blocal}(o) respectively represent sequences θ_{local}(m) and φ_{local}(o) in the computing element “B”. Further, η(θ_{Blocal}, φ_{Blocal}) in the formula (19) is represented by η=1 in the gas space visible direction of the computing element “B”, and is represented by η=0 in the other directions. Accordingly, the formula (19) can be calculated by using the gas space visible direction of the computing element B counted in step S26.

In the flow of FIG. 6, the visibility factor ν(a, B) and the form factor g(a, B) between the computing elements “a” and “B” are then calculated by using the counting result of step S25 (step S29). The form factor g(a, B) can be expressed as the following formula (20) using the sequences θ_{Blocal}(m) and φ_{Blocal}(o).

$$g ( a , B ) = \frac{1}{M \times O} {\sum }_{m}^{M} {\sum }_{o}^{O} κ ( {θ}_{Blocal} ( m ) , {φ}_{Blocal} ( o ) , a ) \qquad ( 20 )$$

where κ(θ_{Blocal}, φ_{Blocal}, a) represents a result of visibility determination as to whether each computing element “a” is visible in the directions of θ_{local} and φ_{Blocal} from the computing element “B”, and is referred to as a computing element visibility determination value. When the computing element “a” is visible in the directions of θ_{Blocal} and φ_{Blocal} from the computing element “B”, κ(θ_{Blocal}, φ_{Blocal}, a)=1 holds. When the computing element “a” is invisible, κ(θ_{Blocal}, φ_{Blocal}, a)=0 holds. Accordingly, the formula (20) can be calculated in consideration of whether the computing element “a” is counted as the visible computing element of the computing element “B” in step S25.

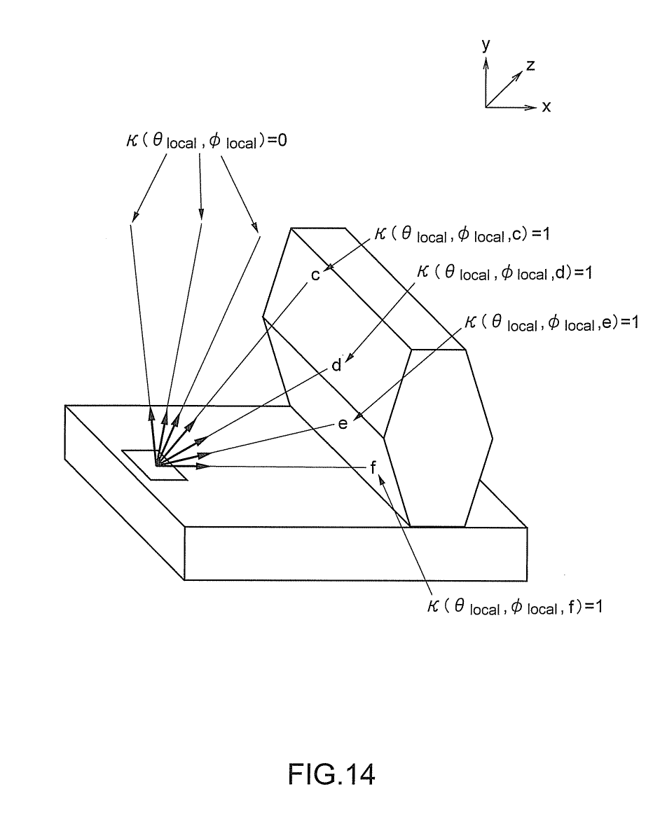

Examples in which the computing element visibility determination value “x” is calculated two-dimensionally and three-dimensionally are illustrated in FIGS. 13 and 14, respectively. FIGS. 13 and 14 are schematic diagrams for illustrating the two-dimensional and three-dimensional computing element visibility determination values “κ”, respectively.

The visibility factor ν(a, B) can be calculated from the calculation result of g(a, B) obtained by the formula (20). Specifically, when g(a, B)=0, ν(a, B)=0 holds, and when g(a, B)>0, ν(a, B)=1 holds.

As described above, in steps S28 and S29, the direct flux Γ_{B,directi} the visibility factor ν(a, B), and the form factor g(a, B) are calculated based on the determination results of step S24. Blocks that perform the processes of steps S28 and S29 are examples of a calculation module of the disclosure.

The calculation results of Γ_{B,direct}, ν(a, B), and g(a, B) obtained by the flow of FIG. 6 are used for the calculation of the total flux Γ_{B}, the surface growth rate Fᵢ, the level set function φₜ, and the like in the flows of FIGS. 1 and 4. Blocks that perform these calculations are also examples of the calculation module of the disclosure.

(3) Calculation Time in First Embodiment

Next, the calculation time in the first embodiment will be described in view of the above description.

In the conventional method, it takes time proportional to the number “N” of computing elements to calculate the direct flux Γ_{B,direct} of any computing element “B”. The reason for this is that loop calculation for the computing element “B” is repeatedly performed “N” times. Further, in the conventional method, it takes time proportional to N² to calculate the visibility factor ν(a, B) and the form factor g(a, B) between arbitrary computing elements “a” and “B”. The reason for this is that loop calculation for the computing element “a” and loop calculation for the computing element B are repeatedly performed “N” times. The calculation time for ν(a, B) and g(a, B) are further increased when the mirror boundary condition or the periodic boundary condition is employed. Accordingly, most of the calculation time in the conventional method are used for the calculation for ν(a, B) and g(a, B).

On the other hand, in this embodiment, as illustrated in FIG. 6, straight lines are extended in a plurality of directions from each computing element “a”, and it is determined whether each straight line contacts the substance surface, and determined which computing element each straight line contacts to calculate, based on the determination results, Γ_{B,direct}, ν(a, B), and g(a, B). Accordingly, ν(a, B) and g(a, B) are calculated by repeatedly performing the loop calculation for the computing element “a” N times as similar to Γ_{B,direct} (see steps S22 and S30). Therefore, according to this embodiment, the calculation time for Γ_{B,direct}, ν(a, B), and g(a, B) can be suppressed to the time proportional to the number “N” of computing elements.

The effect of reducing the calculation time is effective to the case of considering not only the reactive species directly reaching the substance surface but also the reactive species indirectly reaching the substance surface. The reason for this is that, as understood from the formula (3), the reduction in the calculation time for ν(a, B) and g(a, B) leads to a reduction in the calculation time for the indirect flux Γ_{aB,indirect}. Accordingly, this embodiment enables a high-speed topography simulation in consideration of reactive species directly and indirectly reaching the substance surface. The effect of reducing the calculation time in this embodiment as compared with the conventional method becomes more remarkable when the mirror boundary condition or the periodic boundary condition is employed.

In this embodiment, Γ_{B,direct} and g(a, B) are calculated by the formulas (19) and (20), which eliminates the need to calculate sin or cos as shown in the formulas (11) and (13) in a deep loop. Accordingly, this embodiment eliminates a process requiring along calculation time such as sin or con from a deep loop, thereby enabling a further reduction in the calculation time.

In the calculation of g(a, B) of this embodiment, the number of 0 elements in the g(a, B) matrix (and the ν(a, B) matrix) tends to increase as compared with the conventional method that calculates g(a, B) in the N²-time loop calculation. In this embodiment, straight lines are extended in a plurality of directions from each computing element, and it is determined whether each straight line contacts the substance surface and determined which computing element each straight line contacts to calculate the form factor. Consequently, in this embodiment, the probability that the form factor is 0 significantly increases as compared with the case where the loop calculation is performed between all the pairs of the computing elements, so that the ratio of the 0 elements to all the matrix elements in the g(a, B) matrix becomes ½ or more (more specifically, 0.8 or more in many cases). In this case, half or more of non-diagonal elements of matrix “A” in formula (9) become 0, and the matrix equation of formula (6) becomes a simple form. Therefore, according to this embodiment, the calculation time and memory usage can be significantly reduced.

Accordingly, in the case of performing chemical reaction calculation while repeatedly solving the matrix equation of the formula (6), this embodiment employs a calculation algorithm focusing on these 0 elements, thereby enabling a further reduction in the calculation time. Furthermore, the employment of a sparse matrix holding algorithm such as CRS enables memory saving as the number of 0 elements increases. In this case, the matrix equation of formula (6) is repeatedly solved until the adhesion probability Sᵢ(Γᵢ) is converged in step S15 of FIG. 4. In this calculation, since the calculation time for solving the formula (6) once is reduced due to its many 0 elements, the total calculation time in step S15 is significantly reduced.

In this embodiment, to calculate Γ_{B,direct}, ν(a, B), and g(a, B), loop calculation for the zenith angle θ_{local} and the azimuth angle θ_{local} are performed in steps S22 to S27. In steps S28 and S29, Γ_{B,direct}, ν(a, B), and g(a, B) are calculated from the result of this loop calculation. In this manner, in this embodiment, Γ_{B,direct}, ν(a, B), and g(a, B) are calculated in parallel by the same loop calculation of steps S22 to S27, thereby further reducing the calculation time.

In this embodiment, the area fragment factor f(θ) may be given by a formula other than the formula (13). In this case, the sequence θ_{local} (m) according to the area fragment factor f(θ) given by this formula is determined in step S21.

(4) Modifications of First Embodiment

Next, modifications of the first embodiment will be described.

(4.1) Omission of Loop Calculation

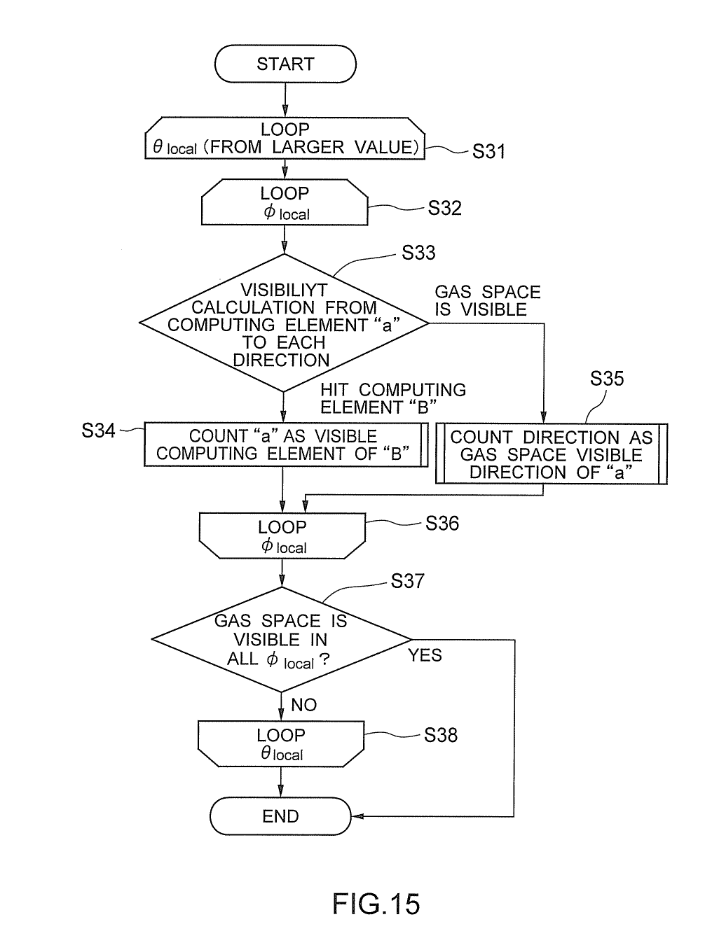

FIG. 15 is a flowchart illustrating a modification of a procedure of steps S22 to S27 in FIG. 6.

Steps S33 to S35 in FIG. 15 respectively correspond to steps S24 to S26 in FIG. 6. FIG. 15 illustrates that the processes of steps S33 to S35 are sequentially carried out from the directions in which the zenith angle θ_{local} is larger to the directions in which the zenith angle θ_{local} is smaller (steps S31, S32, S36, and S38). For example, when there are three directions in which θ_{local}=θ₁ holds like (θ₁, φ₁), (θ₁, φ₂), (θ₃, φ₃) and there are two directions in which θ_{local}=θ₂ holds like (θ₂, φ₄), (θ₂, φ₅) where θ₁>θ₂ is established, the processes of steps S33 to S35 are first performed for the former three directions, and the processes of steps S33 to S35 are then performed for the latter two directions.

In this loop calculation, every time the processes of steps S33 to S35 is finished for all the azimuth angle values φ_{local} with the same zenith angle value θ_{local}, it is confirmed whether the visibility determination values η(θ_{local}, φ_{local}) at these azimuth angle values φ_{local} indicate “1” (step S37). The azimuth angle values φ_{local} mean the values of the azimuth angle φ_{local} such as φ₁, φ₂, φ₃, φ₄, φ₅, and the zenith angle values θ_{local} mean the values of the zenith angle θ_{local} such as θ₁, θ₂.

When these visibility determination values n indicate “1” (that is, the straight lines of the directions of these azimuth angle values φ_{local} do not contact the substance surface), the subsequent loop calculation is omitted, and the flow of FIG. 15 is ended. For example, when the visibility determination value η is “1” at any azimuth angle θ_{local} in the directions in which the zenith angle θ_{local} is θ₀ (θ₀ is a constant), all loop calculation in the directions in which the zenith angle θ_{local} is smaller than θ₀ is omitted.

The reason that such a process is performed is that when the straight lines in all the directions in which the zenith angle θ_{local} is θ₀ reaches the gas space, the substance surface does not exist in the range of the zenith angle θ_{local} from 0 to θ₀ in many cases, and the straight lines in all the directions in which the zenith angle θ_{local} is smaller than θ₀ also reach the gas space in many cases. Accordingly, in this modification, the loop calculation for these directions is omitted, and all of these directions are counted as the gas space visibility directions. This enables a reduction in useless loop calculation and a further reduction in the calculation time.

(4.2) Global Coordinate

In this embodiment, the local coordinate system unique to each computing element is used in the flows of FIGS. 6 and 15. Alternatively, a global coordinate system common to all computing elements may be used.

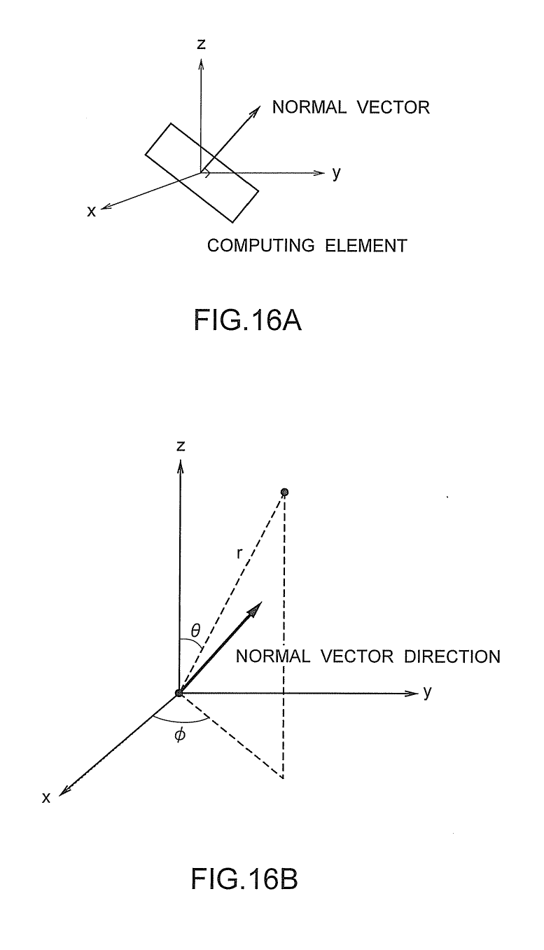

FIGS. 16A and 16B are diagrams for illustrating a global coordinate system. FIG. 16A illustrates a normal vector of each computing element. FIG. 16B illustrates orthogonal coordinates (x, y, z) and polar coordinates (r, θ, φ) of the global coordinate system.

In the case of using the global coordinate system, the direct flux Γ_{B,direct} and the form factor g(a, B) can be respectively expressed as the following formulas (21) and (22) by the sequences θ_{B}(m), φ_{B}(o), and θ_{Bin}(m) of the global coordinate system.

$$\begin{matrix}{Γ}_{B , direct} = \frac{{f}_{flat}}{M \times O} {\sum }_{m}^{M} {\sum }_{o}^{O} \frac{η ( {θ}_{B} ( m ) , {φ}_{B} ( o ) )}{cos {θ}_{B} ( m )} cos {θ}_{Bin} ( m ) & ( 21 ) \\ g ( a , B ) = \frac{1}{M \times O} {\sum }_{m}^{M} {\sum }_{o}^{O} \frac{κ ( {θ}_{B} ( m ) , {φ}_{B} ( o ) , a )}{cos {θ}_{B} ( m )} cos {θ}_{Bin} ( m ) & ( 22 )\end{matrix}$$

where θ_{B}(m), φ_{B}(o), and θ_{Bin}(m) respectively represents sequences of the zenith angle θ, the azimuth angle φ, and the incident angle θᵢₙ in the computing element “B”.

The use of a local coordinate system has an advantage that the calculation is simplified and the number of errors is reduced. For example, as illustrated in FIG. 8, when the straight line is extended only in the direction on one side of the substance surface, the use of the local coordinate system makes it possible to deal with this only by changing the range of the zenith angle θ_{local} from 0 to π to the range from 0 to π/2. Accordingly, in this case, the use of the local coordinate system simplifies the calculation, resulting in a reduction in errors. On the other hand, the use of the global coordinate system has an advantage that there is no need to consider the difference of coordinate systems between the computing elements.

(4.3) Division Number of Azimuth Angle

In this embodiment, the division number “O” of the azimuth angle φ_{local} is set to be constant regard less of the zenith angle θ_{local}. Alternatively, the division number “O” of the azimuth angle φ_{local} may be change according to the zenith angle θ_{local}. That is, the division number “O” of the azimuth angle φ_{local} may be a variable depending on a pitch “m” of the zenith angle θ_{local}.

Accordingly, when the pitch “o” and the division number “O” of the azimuth angle φ_{local} at the zenith angle θ_{local} (m) are respectively represented by “oₘ” and “Oₘ”, the formulas (15), (19), and (20) are respectively rewritten into the following formulas (23), (24), and (25).

$$\begin{matrix}{φ}_{local} ( {o}_{m} ) = \frac{2 π ( {o}_{m} + 0.5 )}{{O}_{m}} & ( 23 ) \\ {Γ}_{B , direct} = \frac{{f}_{flat}}{M} {\sum }_{m}^{M} \frac{1}{{O}_{m}} {\sum }_{{o}_{m}}^{{O}_{m}} η ( {θ}_{Blocal} ( m ) , {φ}_{Blocal} ( {o}_{m} ) ) & ( 24 ) \\ g ( a , B ) = \frac{1}{M} {\sum }_{m}^{M} \frac{1}{{O}_{m}} {\sum }_{{o}_{m}}^{{O}_{m}} κ ( {θ}_{Blocal} ( m ) , {φ}_{Blocal} ( {o}_{m} ) , a ) & ( 25 )\end{matrix}$$

The effects of the first embodiment as described above and described below can be obtained also when the division method for the azimuth angle φ_{local} is used. Such a division method can be applied not only to a local coordinate system but also to a global coordinate system.

(5) Effects of First Embodiment

Lastly, the effects of the first embodiment will be described.

As described above, in this embodiment, straight lines are extended in a plurality of directions from each computing element, it is determined whether each straight line contacts the substance surface and determined which computing element each straight line contacts, and the direct flux and the form factor are calculated based on the determination results. Further, the visibility factor is calculated based on the determination results.

Therefore, according to this embodiment, the calculation time for the direct flux and form factor can be suppressed to time proportional to the number of computing elements. Therefore, according to this embodiment, the calculation time for the form factor that affects the calculation time for the indirect flux can be shortened, thereby enabling the topography simulation to be performed high-speed in consideration of the reactive species directly or indirectly reaching the substance surface.

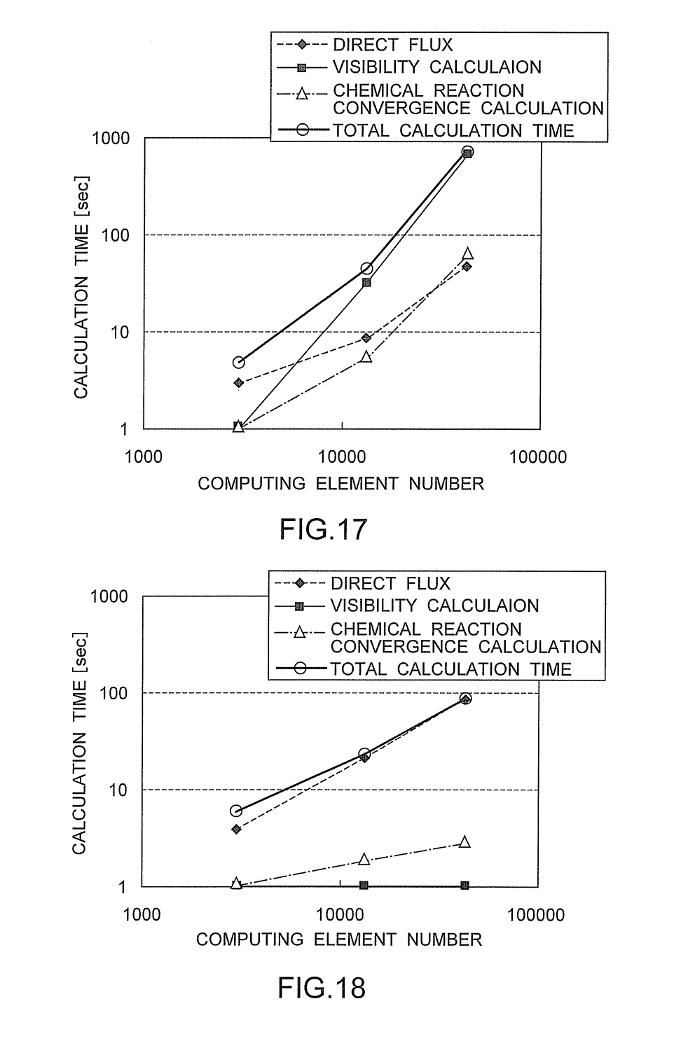

FIGS. 17 and 18 are graphs illustrating examples of the calculation time in a comparative example and the first embodiment, respectively. In the comparative example, the direct flux, visibility factor, and form factor are calculated using the conventional method. FIGS. 17 and 18 illustrate the calculation time for the direct flux, the calculation time for visibility calculation (calculation of the visibility factor and the form factor), the calculation time for chemical reaction convergence calculation, and the total of the entire calculation time in the case where the structure shown in FIG. 2 is the initial structure.

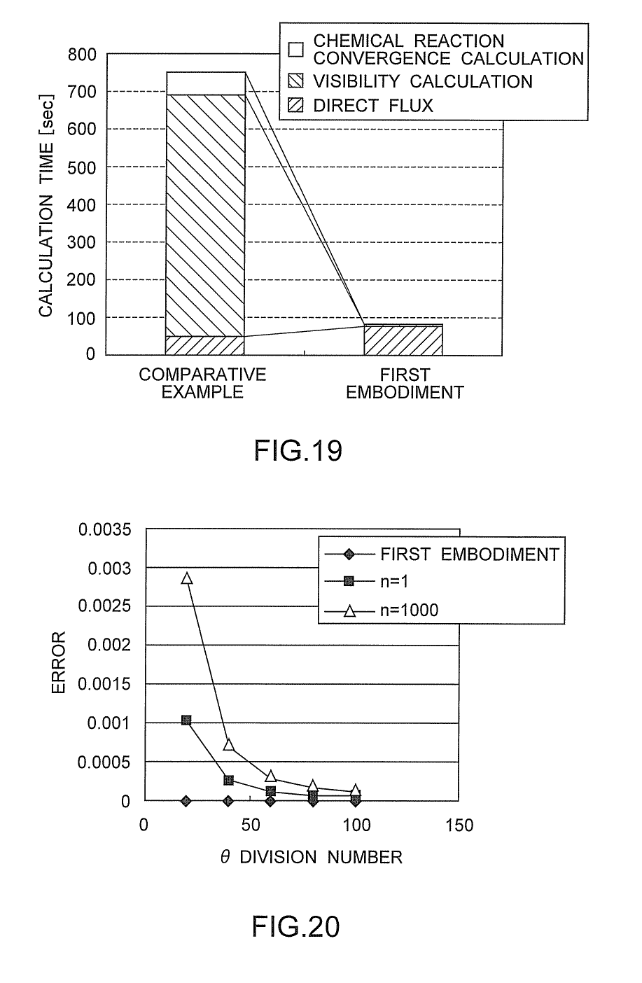

As illustrated in FIGS. 17 and 18, according to the first embodiment, the entire calculation time can be shortened as compared with the comparative example. These comparison results are illustrated in FIG. 19. FIG. 19 is a graph illustrating a comparison between the calculation time of the first embodiment and the comparative example when the number of computing elements is 40000.

FIG. 20 is a graph illustrating a relation between a “θ” division number and a calculation error in the first embodiment and the comparative example. Here, the local coordinate system is used for the calculation illustrated in FIG. 20. The graphs of n=1 and n=1000 illustrate the calculation results of the comparative example. As is obvious from FIG. 20, the calculation errors can be suppressed according to the first embodiment.

The topography simulation method of the first embodiment may be executed using any information processing apparatus. In a second embodiment, a topography simulation apparatus will be described as an example of such an information processing apparatus.

### Second Embodiment

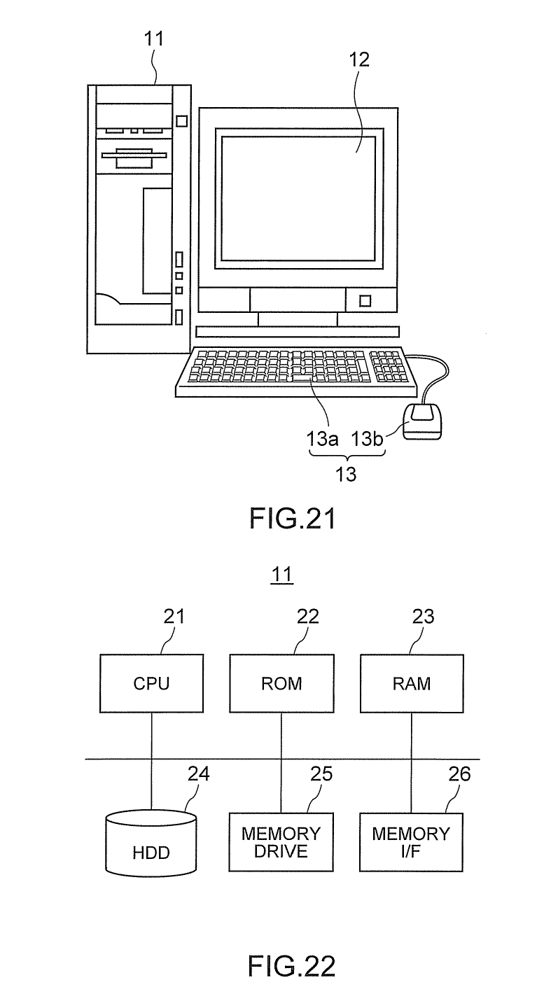

FIG. 21 is an outline view illustrating a configuration of the topography simulation apparatus of the second embodiment.

The topography simulation apparatus illustrated in FIG. 21 includes a control module 11, a display module 12, and an input module 13.

The control module 11 controls the operation of the topography simulation apparatus. The control module 11 executes the topography simulation method of the first embodiment, for example. The control module 11 will be described in detail later.

The display module 12 includes a display device such as a liquid crystal monitor. The display module 12 displays a configuration information input screen for the topography simulation, and a calculation result of the topography simulation, for example.

The input module 13 includes input devices such as a keyboard 13a and a mouse 13b. The input module 13 is used for inputting configuration information for the topography simulation, for example. Examples of the configuration information include information on a calculation formula, information on an experimental value or a predicted value, information on the structure of the substance, information on a flux, and instruction information on the configurations and procedures for the topography simulation.

FIG. 22 is a block diagram illustrating a configuration of the control module 11 of FIG. 21.

The control module 11 includes a CPU (central processing unit) 21, a ROM (read only memory) 22, a RAM (random access memory) 23, an HDD (hard disk drive) 24, a memory drive 25 such as a CD (compact disc) drive, and a memory I/F (interface) 26 such as a memory port or a memory slot.

In this embodiment, a topography simulation program, which is a program for the topography simulation method of the first embodiment, is stored in the ROM 22 or the HDD 24. Upon receiving predetermined instruction information from the input module 13, the CPU 21 reads out the program from the ROM 22 or the HDD 24, develops the read program in the RAM 23, and executes the topography simulation by this program. Various data generated during this process are held in the RAM 23.

In this embodiment, a computer readable recording medium stores the topography simulation program, and a topography simulation program may be installed from the recording medium into the ROM 22 and the HDD 24. Examples of the recording medium include a CD-ROM and a DVD-ROM (digital versatile disk ROM).

Further, in this embodiment, the topography simulation program can be downloaded via a network such as the Internet to be installed in the ROM 22 and the HDD 24.

As described above, according to this embodiment, it is possible to provide a topography simulation apparatus and a topography simulation program for executing the topography simulation method of the first embodiment.

In the first and second embodiments, a semiconductor device is adopted as an example of the object to which the topography simulation is applied, but the topography simulation can also be applied to devices other than the semiconductor device. Examples of such devices include a micro electro mechanical systems (MEMS) device and a display device.

While certain embodiments have been described, these embodiments have been presented by way of example only, and are not intended to limit the scope of the inventions. Indeed, the novel apparatuses, methods and media described herein may be embodied in a variety of other forms; furthermore, various omissions, substitutions and changes in the form of the apparatuses, methods and media described herein may be made without departing from the spirit of the inventions. The accompanying claims and their equivalents are intended to cover such forms or modifications as would fall within the scope and spirit of the inventions.

1. A topography simulation apparatus comprising:
a division module configured to divide a surface of a substance into a plurality of computing elements;
a determination module configured to extend straight lines in a plurality of directions from each computing element, and configured to determine whether each straight line contacts the surface of the substance and determine which computing element each straight line contacts; and
a calculation module configured to calculate, based on results of the determinations, a direct flux which is a flux of a reactive species directly reaching each computing element, and a form factor indicating a positional relationship between the computing elements.

2. The apparatus of claim 1, wherein the calculation module calculates, by using the direct flux and the form factor, at least one of a total flux which is a flux of the reactive species directly or indirectly reaching each computing element, and a local surface growth rate of the substrate.

3. The apparatus of claim 2, wherein
the calculation module calculates, based on the results of the determinations, a visibility factor indicating whether the computing elements are visible to each other, and
the calculation module calculates, by using the direct flux, the visibility factor and the form factor, at least one of the total flux and the surface growth rate.

4. The apparatus of claim 2, wherein the calculation module performs a time evolution on a level set function defined with a distance from the surface of the substance by using at least one of the total flux and the surface growth rate to calculate a change of topography of the substance.

5. The apparatus of claim 2, wherein the calculation module expresses the form factor by a form factor matrix in which half or more of matrix elements are zero, and solves a matrix equation including the matrix elements of the form factor matrix to calculate at least one of the total flux and the surface growth rate.

6. The apparatus of claim 5, wherein the calculation module calculates at least one of the total flux and the surface growth rate by repeatedly solving the matrix equation until an adhesion probability indicating a ratio of the total flux absorbed on each computing element is converged.

7. The apparatus of claim 1, wherein
the calculation module calculates each of the direct flux and the form factor by loop calculation for a zenith angle θ and an azimuth angle φ which represent a direction of each straight line, and
the calculation module performs the loop calculation sequentially from directions in which the zenith angle θ is larger to directions in which the zenith angle θ is smaller, and omits the loop calculation for directions in which the zenith angle θ is smaller than θ₀ when each straight line is determined not to contact the surface of the substance at an arbitrary azimuth angle φ in directions in which the zenith angle θ is θ₀.

8. The apparatus of claim 1, wherein the calculation module calculates the direct flux and the form factor by the same loop calculation for a zenith angle θ and an azimuth angle φ which represent a direction of each straight line.

9. A topography simulation method comprising:
dividing a surface of a substance into a plurality of computing elements;
extending straight lines in a plurality of directions from each computing element, and determining whether each straight line contacts the surface of the substance and determining which computing element each straight line contacts; and
calculating, based on results of the determinations, a direct flux which is a flux of a reactive species directly reaching each computing element, and a form factor indicating a positional relationship between the computing elements.

10. The method of claim 9, further comprising calculating, by using the direct flux and the form factor, at least one of a total flux which is a flux of the reactive species directly or indirectly reaching each computing element, and a local surface growth rate of the substrate.

11. The method of claim 10, further comprising calculating, based on the results of the determinations, a visibility factor indicating whether the computing elements are visible to each other,
wherein at least one of the total flux and the surface growth rate is calculated by using the direct flux, the visibility factor and the form factor.

12. The method of claim 10, further comprising performing a time evolution on a level set function defined with a distance from the surface of the substance by using at least one of the total flux and the surface growth rate to calculate a change of topography of the substance.

13. The method of claim 10, further comprising expressing the form factor by a form factor matrix in which half or more of matrix elements are zero, and solving a matrix equation including the matrix elements of the form factor matrix to calculate at least one of the total flux and the surface growth rate.

14. The method of claim 13, wherein at least one of the total flux and the surface growth rate is calculated by repeatedly solving the matrix equation until an adhesion probability indicating a ratio of the total flux absorbed on each computing element is converged.

15. The method of claim 9, wherein
each of the direct flux and the form factor is calculated by loop calculation for a zenith angle θ and an azimuth angle φ which represent a direction of each straight line, and
the loop calculation is performed sequentially from directions in which the zenith angle θ is larger to directions in which the zenith angle θ is smaller, and omits the loop calculation for directions in which the zenith angle θ is smaller than θ₀ when each straight line is determined not to contact the surface of the substance at an arbitrary azimuth angle φ in directions in which the zenith angle θ is θ₀.

16. The method of claim 9, wherein the direct flux and the form factor is calculated by the same loop calculation for a zenith angle θ and an azimuth angle φ which represent a direction of each straight line.

17. A computer readable recording medium storing a topography simulation program for causing a computer to perform a topography simulation method, the method comprising:
dividing a surface of a substance into a plurality of computing elements;
extending straight lines in a plurality of directions from each computing element, and determining whether each straight line contacts the surface of the substance and determining which computing element each straight line contacts; and
calculating, based on results of the determinations, a direct flux which is a flux of a reactive species directly reaching each computing element, and a form factor indicating a positional relationship between the computing elements.

18. The medium of claim 17, wherein the method further comprises calculating, by using the direct flux and the form factor, at least one of a total flux which is a flux of the reactive species directly or indirectly reaching each computing element, and a local surface growth rate of the substrate.

19. The medium of claim 18, wherein
the method further comprises calculating, based on the results of the determinations, a visibility factor indicating whether the computing elements are visible to each other, and
at least one of the total flux and the surface growth rate is calculated by using the direct flux, the visibility factor and the form factor.

20. The medium of claim 18, wherein the method further comprises performing a time evolution on a level set function defined with a distance from the surface of the substance by using at least one of the total flux and the surface growth rate to calculate a change of topography of the substance.
